(19) United States
(12) Patent Application Publication
(10) Pub. No.: US 2024/0142046 A1
(43) Pub. Date: May 2, 2024

(54) COLUMN TYPE STAND, PARTICULARLY FOR SUPPORTING LIGHTING OR SOUND

(71) Applicant: VIDENDUM MEDIA SOLUTIONS S.P.A., CASSOLA (VI) (IT)

(72) Inventor: Alessandro BECCARO, BRENDOLA (VI) (IT)

(73) Assignee: VIDENDUM MEDIA SOLUTIONS S.P.A., CASSOLA (VI) (IT)

(21) Appl. No.: 18/280,964

(22) PCT Filed: Mar. 8, 2022
(86) PCT No.: PCT/IB2022/052052

§ 371 Date: Sep. 8, 2023

(30) Foreign Application Priority Data
Mar. 10, 2021 (IT) 102021000005627

(51) Int. Cl. F16M 11/28; F16M 11/18; F16M 11/38; F16M 11/42

(52) U.S. Cl. CPC F16M 11/28; F16M 11/18; F16M 11/38; F16M 11/42

(57) ABSTRACT

A stand includes a base, from which there extends a column which is extensible along a longitudinal axis thereof and which is configured to support a sound or lighting system. The base includes at least one arm which is articulated at a proximal end thereof to the column in order to pivot between an open configuration and a folded configuration, and a support element which is fixed to a distal end of the arm and on which there is mounted at least one wheel which is intended to be supported on the ground when the arm is moved into the open configuration.

### TECHNICAL FIELD

The present invention relates to a telescope-like column type stand having the features set out in the preamble of the main claim.

### TECHNOLOGICAL BACKGROUND

The present invention is used particularly, though not exclusively, in the field of entertainment shows, where it is known to support sound or lighting systems on column type supports of the non-fixed type which can be removed and stored when not in use.

These types of stands have to be capable of supporting great loads in the order of several hundreds of kilogrammes and generally comprise a column which extends from a base supported on the ground.

In particular, the column is generally of the telescope-like type and comprises a series of unscrewing portions which are slidingly engaged one inside the other and a raising mechanism, for example, of the type with ropes and pulleys, which controls the mutual extraction and retraction movement of the unscrewing portions. This raising mechanism is generally actuated by cranks which are positioned at the top of the lower unscrewing portion, which is the outermost portion.

In this manner, the column can be extended in order to move the sound or lighting systems to the required height and, at the end of the use thereof, for example, at the end of the entertainment show, it can be lowered in order to allow the removal of the systems and the transport or storage of the stand.

The support base of the column is typically formed by a plurality of arms which extend radially from the lower region of the column in order to increase the support surface thereof and which are articulated at a proximal end thereof to the column so as to be able to pivot them so as to fold near the column when the stand is not in use.

Furthermore, the base is preferably provided with wheels which are suitably mounted at the distal ends of the arms and which are supported on the ground and which allow the convenient movement of the stand when the arms are extended from the column. This feature is highly appreciated by users and becomes particularly important when the stand is heavy.

Therefore, there are known from what has been set out above stands which can take up an operative configuration with an open base and an extended column and a folded, non-operative configuration with a retracted column and closed base.

This leads to the general need to have stands which, in the folded configuration, are compact and take up little space to the greatest possible extent so as to be able to facilitate the transport and storage thereof.

In the context of this general requirement, therefore, the Applicant has further observed how the dimensions of the stand in a folded configuration take on particular importance not only in defining the spatial requirement thereof during transport or storage but also during setting up and preparing the stand for use.

In fact, as anticipated above, it is often necessary to mount at the top of the column lighting and sound systems which are quite heavy and for which it is desirable for the height of the top of the column from the ground when in the retracted position (that is to say, with the unscrewing portions one inside the other) not to be greater than a given measurement, for example, approximately 1 metre, so that this operation, without any external raising members, can be carried out by one or more operators without any need to excessively lift the arms above the body.

In responding to this requirement, the Applicant has observed that the requirements for constructing the stand involve different constraints in relation to the possibility of containing the dimensions thereof when it is placed in the folded configuration.

For example, many known solutions provided for the arms of the base to be articulated, at one proximal end thereof with respect to the column, to a collar which is mounted in a sliding manner on the column and for the direction thereof to be defined by a plurality of rods which extend between the column and a central zone thereof. In this construction type, the folding of the stand is brought about by causing the collar to slide towards the top of the column so that the legs close near the column.

However, the Applicant has established how, in these types of stands, it is difficult to significantly reduce the height of the stand in the folded configuration, being limited in this configuration, on the one hand, by the portion of leg which projects from the base of the column and, on the other hand, by the possible interference of the collar with the raising mechanism of the column which is generally positioned at the top of the first unscrewing portion of the telescope-like column.

The Applicant has further observed that containing the spatial requirement of the stand in the folded configuration is made more complicated when the base is provided with support wheels and particularly when these wheels are pivoting wheels. In this last case, in fact, the wheels, in addition to rotating about the individual main rotation axis thereof which is typically defined by the central hub of the wheel, are able to rotate about a secondary rotation axis which is typically perpendicular to the main rotation axis. In order to allow this movement possibility, the wheel is rotatably mounted on a bracket which is in turn mounted on the arm in a rotatable manner.

In this manner, when the arms are folded against the column, the wheels substantially increase the total spatial requirement of the stand, projecting radially from the column, where applicable interfering with each other or with the column itself.

EP 3283143 sets out a stand for bags of blood for intravenous infusion having a telescope-like column and a base comprising a plurality of articulated arms, at the distal ends of which respective pivoting wheels are fixed.

U.S. Pat. Nos. 7,614,628 and 6,447,002 set out bag-carrying or luggage-carrying foldable carts which are provided with wheels.

In the present description and in the appended claims, the term “main rotation axis” of a wheel is intended to be understood to be the axis which is defined by the hub of the wheel while the term “secondary rotation axis” is intended to be understood to be any other axis, about which the entire wheel is able to rotate, such as, for example, a rotation axis of a support bracket of the wheel.

A wheel having a main rotation axis and a secondary rotation axis is defined as a pivoting wheel.

The term “ground” is intended to be understood to be the surface on which the stand is intended to be supported. Preferably, the ground is substantially planar and, even more preferably, it is horizontal.

It may further be noted that the term “vertical direction” is intended to be understood to be the direction defined by gravitational force and the term “horizontal” plane or direction is intended to be understood to be a plane which is substantially perpendicular to the vertical direction and a direction belonging to this plane, respectively.

The term “longitudinal direction” of an element, for example of an arm, is intended to be understood to be a main extent direction of the element.

### DESCRIPTION OF THE INVENTION

The problem addressed by the present invention is to provide a column type stand which is structurally and functionally configured to comply with the requirements set out above and to at least partially overcome the limitations set out above with reference to the cited prior art.

This problem is solved by the present invention by means of a telescope-like column type stand which is constructed in accordance with the appended claims.

In a first aspect, therefore, the present invention is directed towards a stand comprising a base, from which there extends a column which is extensible along a longitudinal axis thereof and which is configured to support a sound or lighting system.

The base comprises at least one arm which is movable between an open configuration, in which the arm extends away from the column, and a folded configuration, in which the arm is moved towards the column.

Preferably, the at least one arm extends in a longitudinal direction between a proximal end and a distal end with respect to the column.

Preferably, the at least one arm is movable between the open configuration and the folded configuration by pivoting about an articulation axis passing through the proximal end.

The base further comprises a support element which is mounted on the arm and on which there is mounted at least one wheel which is intended to be supported on the ground when the arm is moved into the open configuration.

Preferably, the support element is mounted on the arm at the distal end thereof.

Furthermore, the support element is selectively movable with respect to the arm between a first operative position, in which the wheel is orientated in such a manner that the main rotation axis thereof is substantially parallel with the ground when the arm is moved into the open configuration, and a second non-operative position, in which the support element and the wheel are moved towards the column when the arm is moved into the folded configuration.

Preferably, the support element is further selectively movable between the first operative position and the second non-operative position by means of pivoting about a pivoting axis which is substantially parallel with the longitudinal direction of the arm.

As a result of the features mentioned above, in the stand according to the present invention the support element can be moved in such a manner that the wheel which is mounted thereon is always orientated in the most appropriate manner with respect to the configuration of the arm.

In particular, when the arm is moved into the open configuration, the support element can be moved into the first operative position so that the wheel is orientated with the main rotation axis thereof substantially parallel with the ground, allowing the correct support thereof on the ground and the possibility of rolling thereon.

Conversely, when the arm is moved into the folded configuration, the support element can be moved into the second non-operative position so that the wheel and the same support element are orientated so as to limit the overall spatial requirement of the stand to the greatest possible extent.

The magnitude of the movement of the support element into the second non-operative position will advantageously be defined by the designer in accordance with the geometry and the requirements of the single stand model so as to minimize the spatial requirements when the arms are in the folded configuration.

Furthermore, in the aspect mentioned above, the stand according to the present invention may have one or more of the preferred features set out below.

In some embodiments, the support element comprises a frame which is connected to the arm and a bracket which supports the wheel during the rotation thereof about the main rotation axis.

Preferably, the bracket is connected to the frame by means of a rotatable coupling in order to rotate about a secondary rotation axis which is substantially perpendicular to the main rotation axis.

In this manner, the wheel is a pivoting wheel so that the wheel can become orientated automatically in any direction of travel in order to make the stand easier to move.

In a preferred form, the support element is pivoted about the pivoting axis through an angle between 30° and 90°, preferably between 60° and 80°, between the first operative position and the second non-operative position.

In this manner, the support element and the relevant wheel can be orientated in a sufficiently wide manner to reduce the radial spatial requirement of the stand when the arms are in a compact configuration but at the same time with this inclination the ground is touched only by the wheels when the arms are lowered in the open configuration.

Other components of the arm or the support element are thereby prevented from striking the ground and being able to become damaged.

In some embodiments, the base comprises a cross-member, to which the column is fixed and the arm is articulated to the cross-member in the region of a proximal end thereof so that the arm, when it is moved into the folded configuration, preferably extends towards a top of the column.

It is thereby also possible to contain the axial dimension of the stand in an optimum manner when it is in the compact configuration.

In some embodiments, the arm is retained in the open configuration by means of a retention system comprising a strut which is articulated to the column and which can be selectively engaged with the arm.

The stability of the column is thereby ensured even when raised with the sound and lighting system mounted at the top thereof.

Furthermore, the length of the strut is preferably adjustable so as to better become adapted to configurations of the ground which are not completely planar and to better adjust the positioning of the column in a vertical direction, ensuring the stability of the column.

### BRIEF DESCRIPTION OF THE DRAWINGS

The features and advantages of the invention will be better appreciated from the detailed description of a preferred embodiment thereof which is illustrated by way of non-limiting example with reference to the appended drawings, in which:

FIG. 1 is a perspective side view of a column type stand constructed according to the present invention, wherein the arms of the base are pivoted into an open configuration and the support elements are pivoted into a first operative position,

FIG. 2 is a perspective front view of the stand of FIG. 1 with the arms in a folded configuration and the support elements pivoted into a second non-operative position,

FIG. 3 is a perspective front view of the stand of FIG. 1 with the arms in an open configuration and the support elements pivoted into the second non-operative position,

FIG. 4 is a perspective rear view of the stand of FIG. 3,

FIG. 5 is a perspective front view of the stand of FIG. 3 in a subsequent operative configuration,

FIG. 6 is a perspective front view of the stand of FIG. 1,

FIG. 7 is a side view, drawn to an enlarged scale, of a detail of the stand of FIG. 1.

### PREFERRED EMBODIMENT OF THE INVENTION

In the Figures, there is generally designated 1 a column type stand which is constructed according to the present invention.

The stand 1 is provided to support a sound system or a lighting system which is conventional per se and which is therefore not illustrated in the appended Figures.

The stand 1 comprises a column 2 and a base 10 which is supported on the ground T and which is provided to support and fix the column 2 in an upright position.

The column 2 extends in a longitudinal direction Z between a lower end 3 and a top 4 which are longitudinally opposite each other.

The lower end 3 is supported on the base 10 while an attachment is provided at the top 4 for fixing the sound or lighting system.

The column 2 can be extended in a telescope-like manner and comprise a plurality of tubular unscrewing portions which are received with the ability to slide one inside the other to a limited extent.

The stand 1 further comprises a raising device (for example, of the rope and pulley type or chain and reel type) which is positioned inside the unscrewing portions and which is configured to extract the unscrewing portions with respect to each other, thereby extending the column 2 in the longitudinal direction Z, or to retract the unscrewing portions one inside the other, shortening the column 2.

The raising device is known per se in stands of the type described here and will not be described in greater detail.

The Figures illustrate the column 2 in a lowered position, wherein only a first unscrewing portion thereof, the lower one which is external and fixed in support on the base 10, can be seen.

The raising device is controlled by a crank mechanism 6 which is positioned outside the column 2 at the end of the first unscrewing portion opposite the base 10.

The base 10 comprises a cross-member 11, on which the lower end of the column 2 is supported and fixed and to which three arms 12 which are angularly equidistant from and substantially identical to each other are articulated.

Each arm 12 extends in a main longitudinal direction X between a proximal end 13 which is articulated to the cross-member 11 and a distal end 14 which is remote from the cross-member 11.

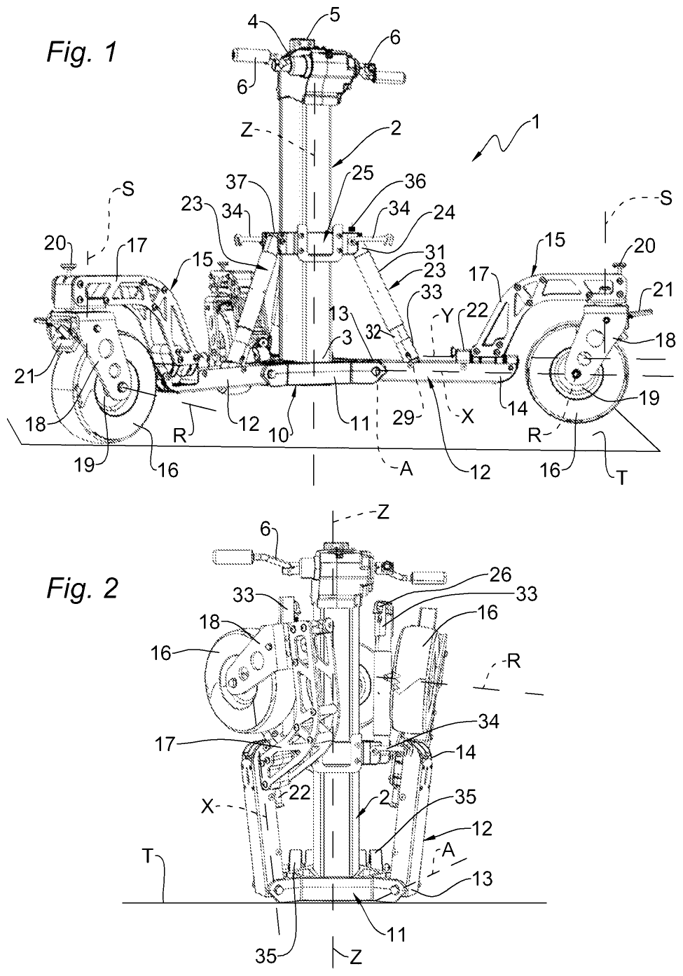

Each arm 12 can be pivoted about an articulation axis A which passes through the proximal end 13 between an open configuration, which is illustrated, for example, in FIG. 1 and in which the arm 12 extends away from the column 2, and a folded configuration which is illustrated in FIG. 2 and in which the arm 12 is near the column 2, with the distal end 14 thereof directed towards the top 4 of the column 2.

Particularly when the arm 12 is in the open configuration, the longitudinal axis X thereof is inclined with respect to the longitudinal axis Z of the column 2 at an angle of approximately 90° while, when it is in the folded configuration, the longitudinal axis X thereof is inclined with respect to the longitudinal axis Z of the column 2 at an angle which is as small as possible, for example, of approximately from 10° to 20°.

At the distal end 14 of each arm 12, there is mounted a support element 15 which carries a wheel 16 for support on the ground T when the arm 12 is pivoted into the open configuration.

The support element 15 comprises a frame 17 which is connected to the arm 12 and a bracket 18 which supports the wheel 16 at a hub 19 thereof which defines the main rotation axis R of the wheel 16.

The wheel 16 is preferably a pivoting wheel as a result of the rotatable coupling between the bracket 18 and the frame 17 which is configured to rotate about a secondary rotation axis S which is substantially perpendicular to the main rotation axis R (though in staggered planes).

The rotation of the bracket 18 with respect to the frame 17 about the secondary rotation axis S is free or can be locked in one or more predefined positions by a locking pin 20 which is capable of engaging with one or more holes formed in the upper portion of the bracket 18.

The support element 15 further comprises a brake 21 which is mounted on the bracket 18 and which can be pivoted away from and towards the wheel 16 in order to selectively block the rotation thereof about the individual main rotation axis R.

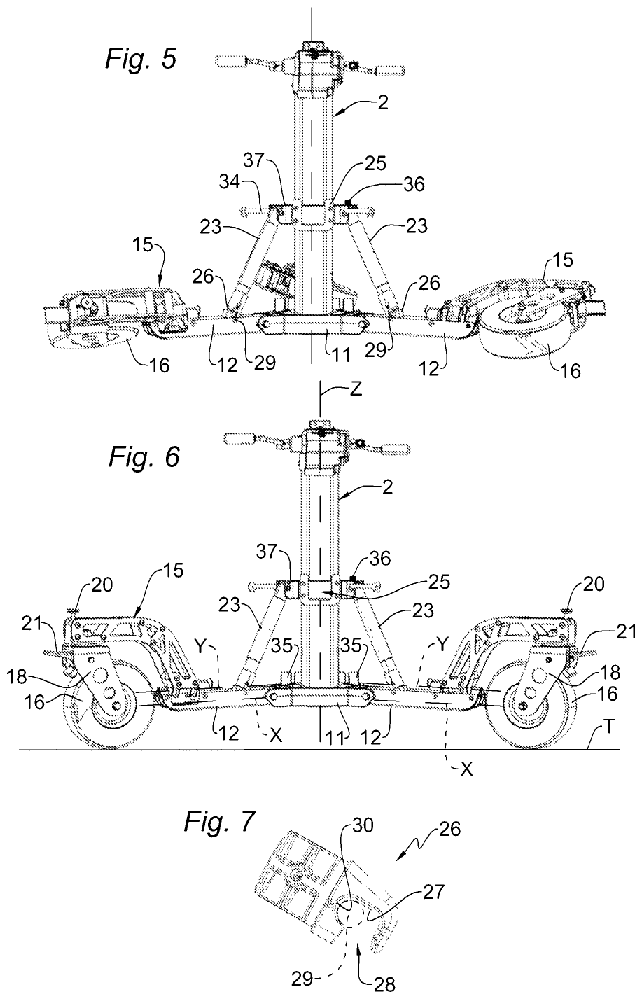

The support element 15 can be selectively pivoted about a pivot axis Y which is substantially parallel with the longitudinal direction X of the arm 12 between a first operative position, which is illustrated in FIGS. 1 and 6, and a second non-operative position, which is illustrated in FIGS. 2 to 5.

In the first operative position, the support element 15 is pivoted in such a manner that the wheel 16 is orientated so that the main rotation axis R is substantially parallel with the ground T when the arm 12 is pivoted into an open configuration.

In this arrangement of the arm and support element, the frame 17 is substantially parallel with the plane which is defined by the pivoting of the arm 12 which extends above the wheel 16 which is supported and can normally roll on the ground T.

In the second non-operative position, the support element 15 is pivoted in such a manner that the frame 17 and the wheel 16 are moved towards the column 2 when the arm 12 is moved into a folded configuration (see FIG. 2) so as to reduce to the greatest possible extent the total spatial requirement of the stand 1 in this configuration.

In the embodiment described here, the support element 15 while changing from the first operative position to the second non-operative position is pivoted about the pivoting axis Y through an angle of approximately 70° (denoted C in FIG. 4).

The pivoting of the support element 15 with respect to the arm 12 about the pivot axis Y is preferably locked in the first operative position or in the second non-operative position by a locking device 22.

The base 10 further comprises a retention system for each arm 12 comprising a respective strut 23 which is articulated to the column 2 and which can be selectively engaged with the arm 12 in order to retain it in the open configuration.

Each strut 23 is articulated with a first end 24 thereof to a collar 25 which is fixed to the column 2 at a specific distance from the lower end 3 thereof and has at the opposite end thereof an engagement element 26 which is configured to engage the arm 12.

In particular, as better shown in FIG. 7, the engagement element 26 has a seat 27 which is C-shaped with an inlet and outlet opening 28 for a pin 29 (indicated with broken lines in FIG. 7) which is fixed to the arm 12 transversely to the longitudinal direction X. The seat 27 of the engagement element 26 is further advantageously provided with a recess 30 which is formed to engage with the pin 29 when it is received in the seat 27 and to prevent it from becoming inadvertently disengaged.

The length of each strut 23 is further advantageously adjustable as a result of the provision of two unscrewing portions 31, 32 which are connected to each other in a screwed manner.

In order to further ensure the retention of the pin 29 in the seat 27 of the engagement element 26, each strut 23 is further provided with a safety element 33 which is resiliently urged so as to close the opening 28.

The safety element 33 can be actuated selectively by an operator in order to release the opening 28 and to allow the introduction and removal of the pin 29 into/from the seat 27.

There are further fixed to the collar 25 hooks 34 which are provided to engage with the arms 12 when they are pivoted into a folded configuration and a levelling bubble 36 which is provided to measure the orientation of an upper surface 37 of the collar 25 with respect to the horizontal plane. Advantageously, the collar 25 is fixed to the column 2 in such a manner that the upper surface 37 of the collar 25 is perpendicular to the longitudinal direction Z of the column 2 so that a verticality condition of the column 2 corresponds to the horizontality condition of the upper surface 37.

A pair of auxiliary wheels 35 are further mounted on the cross-member 11 in order to allow the advantageous movement of the stand 1 when the arms 12 are in a folded configuration.

The stand 1 is used in the following manners.

With reference to FIG. 2, when the arms 12 are pivoted into a folded configuration and the support element is pivoted into the second non-operative position, the stand 1 has a particularly compact configuration both along the axial dimension which is defined by the longitudinal axis of the column 2 and along the radial dimension which is perpendicular thereto.

In this configuration, the struts 23 are disengaged from the arms 12 and are pivoted towards the top 4 of the column 2 as are the arms 12 which are retained in this position by the hooks 34. The support elements 15 and the wheels 16 which are blocked in terms of the rotation thereof about the secondary rotation axis S by the locking pin 20 are mutually co-planar and are placed against the respective strut 23 near the column 2.

The engagement elements 26 of the struts 23 and the support elements 15 together with the respective wheels 16 are directed towards the top 4 of the column 2 but without interfering with the crank mechanism 6.

The stand 1, in this compact configuration which is suitable for the transport and the storage thereof, is supported on the ground T with the cross-member 11 and with the auxiliary wheels 35.

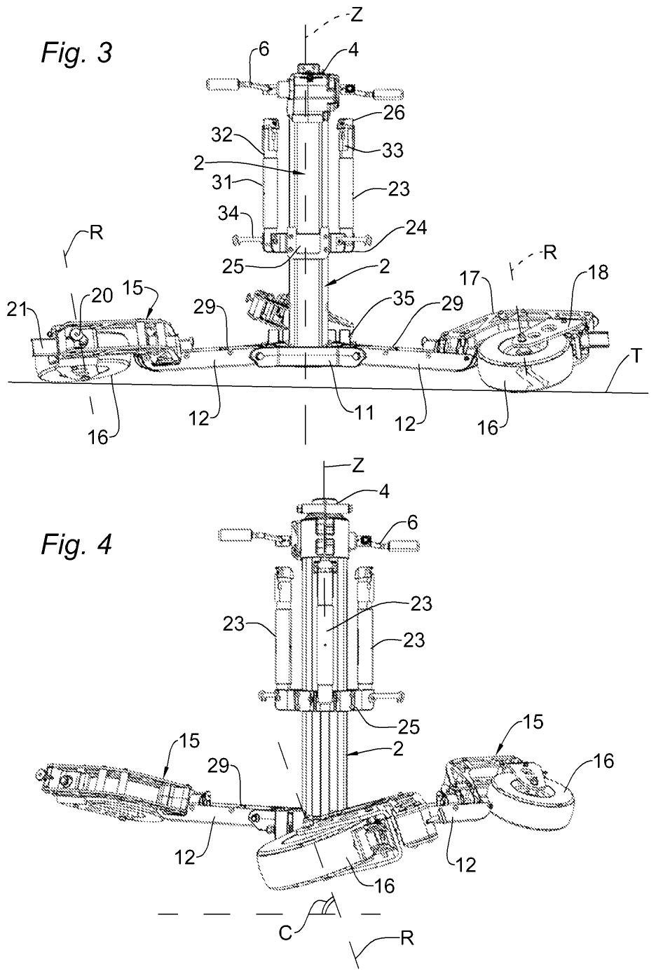

In order to bring the stand 1 into a configuration suitable for supporting a sound or lighting system, the arms 12 are released from the hooks 34 and are accompanied in terms of pivoting about the pivoting axis A until the wheels 16 are supported on the ground T (FIGS. 3 and 4), retaining the support elements 15 in the second non-operative position.

It will be noted that, as a result of the fact that the support elements 15 in the second non-operative position are pivoted through an angle less than 90° with respect to the first operative position (shown more clearly in FIG. 4), the wheel is the only component to touch the ground, preventing possible impacts of the bracket 18 or the frame 17 if the arm 12 should accidentally fall from the folded position.

At this point, the struts 23 are lowered and engaged with the respective arm 12.

Once the struts 23 are fixed to the respective arms 12, the support elements 15 are pivoted into the first operative position by rotating about the pivoting axis Y, where they are then locked by the locking device 22.

At this point, the cross-member 11 is raised off the ground T so as to bring the secondary rotation axes S into a position perpendicular to the ground T and thereby to allow the correct rotation of the wheels 16 about the secondary rotation axes S.

This operation is carried out by extending the struts 23, rotating the unscrewing portion 31 with respect to the unscrewing portion 32.

Advantageously, there is further formed on the struts 23 a reference sign which indicates when the optimum extension is reached, corresponding to the above-mentioned condition of perpendicularity of the secondary axes S with respect to the ground T.

If necessary, the stand 1 can be moved by unblocking the rotation of the wheels 16 about the respective secondary rotation axes S, disengaging the locking pin 20.

Once the working position provided for the stand 1 has been reached, the wheels 16 are orientated with the main rotation axis R perpendicular to the longitudinal axis X of the respective arm 12 and blocked in this position by the locking pin 20 and the brake 21.

Before the sound or lighting system is fixed, the correct positioning of the column 2 in the vertical direction is controlled as a result of the levelling bubble 36 which is positioned on the upper surface 37 of the collar 25 so that any deviations from the vertical state can be corrected by acting with appropriate adjustments of the length of the struts 23.

At this point, the sound or lighting system can be fixed to the top 4 of the column at the attachment 5 and raised to the desired height by lifting the column 2 by means of the crank mechanism 6.

Therefore, the present invention solves the problem set out above with reference to the cited prior art, at the same time affording a number of other advantages, including excellent stability of the column and a high level of simplicity for the stand to change from the operative configuration to the compact configuration.

Naturally, in order to comply with specific and contingent application requirements, a person skilled in the art may apply to the above-described invention additional modifications and variants which are still included within the scope of protection as defined by the appended claims.

1. A stand (1) comprising a base (10), from which there extends a column (2) which is extensible along a longitudinal axis (Z) thereof and which is configured to support a sound or lighting system, wherein the base (10) comprises:
at least one arm (12) which extends in a longitudinal direction (X) between a proximal end (13) and a distal end (14) with respect to the column (2), the arm being movable by means of pivoting about an articulation axis (A) which passes through the proximal end (13), between an open configuration, in which the arm (12) extends away from the column (2), and a folded configuration, in which the arm (12) is moved towards the column (2),
a support element (15) which is mounted on the arm (12) at the distal end (14) and on which there is mounted at least one wheel (16) which is intended to be supported on the ground (T) when the arm (12) is moved into the open configuration,
wherein the support element (15) is selectively movable with respect to the arm (12) between a first operative position, in which the wheel (16) is orientated in such a manner that the main rotation axis (R) thereof is substantially parallel with the ground (T) when the arm (12) is moved into the open configuration, and a second non-operative position, in which the support element (15) and the wheel (16) are moved towards the column (2) when the arm (12) is moved into the folded configuration, and wherein the support element (15) is selectively movable between the first operative position and the second non-operative position by means of pivoting about a pivoting axis (Y) which is substantially parallel with the longitudinal direction (X) of the arm (12).

2. The stand according to claim 1, wherein the support element (15) comprises a frame (17) which is connected to the arm (12) and a bracket (18) which supports the wheel (16) during rotation thereof about the main rotation axis (R), and wherein the bracket (18) is connected to the frame (17) by means of a rotatable coupling in order to rotate about a secondary rotation axis (S) which is substantially perpendicular to the main rotation axis (R).

3. The stand according to claim 1, wherein the support element (15) is pivoted about the pivoting axis (Y) through an angle between 30° and 90°.

4. The stand according to claim 3, wherein the support element (15) is pivoted about the pivoting axis (Y) through an angle between 60° and 80°.

5. The stand according to claim 1, further comprising a locking device (22) for retaining the support element (15) in the first operative position or in the second non-operative position.

6. The stand according to claim 1, wherein the base (10) comprises a cross-member (11), to which the column (2) is fixed and the arm (12) is articulated to the cross-member (11) in the region of the proximal end (13).

7. The stand according to claim 1, wherein the arm (12), when moved into the folded configuration, extends towards a top (4) of the column (2).

8. The stand according to claim 1, further comprising a retention system for the arm comprising a strut (23) which is articulated to the column (2) and which can be selectively engaged with the arm (12) when moved into the open configuration in order to retain the arm (12) in the open configuration.

9. The stand according to claim 8, wherein the strut (23) has an adjustable length.

10. The stand according to claim 8, wherein the strut (23) comprises an engagement element (26) which is configured to engage the arm (12) and to prevent disengagement of the engagement element (23) from the arm (12).

11. The stand according to claim 8, wherein the strut (23) is provided with a safety element (33) which is selectively operable by an operator in order to prevent disengagement of the engagement element (23) from the arm (12).
